(19) United States
(12) Patent Application Publication
(10) Pub. No.: US 2005/0200738 A1
(43) Pub. Date: Sep. 15, 2005

(54) Mode selection switch of photographing device

(75) Inventor: Su-Kyoung Song, Euiseong-gun (KR)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Samsung Electric Co., Ltd.

(21) Appl. No.: 11/049,935

(22) Filed: Feb. 4, 2005

(30) Foreign Application Priority Data
Mar. 10, 2004 (KR) 2004-16046

(51) Int. Cl. H04N 5/222

(52) U.S. Cl. 348/333.02; 348/333.11

(57) ABSTRACT

A mode selection switch of a photographing device comprising a mode display unit for displaying the first operation mode with a highest usage frequency at one end, displaying the second operation mode with a second highest usage frequency at the other end, and displaying the third operation mode with a third highest usage frequency at the center of both ends, and a mode selection unit for indicating the first, second, and third operation modes arranged in order on the mode display unit. A user inputs a mode selection command to the mode selection unit to select one of the first, second, and third operation modes. Therefore, the user can easily select a desired operation mode without even looking at the mode selection switch and thus, the user's convenience is substantially improved.

### CROSS-REFERENCE TO RELATED APPLICATIONS

This application claims the benefit of Korean Patent Application No. 2004-16046, entitled “Mode Selection Switch of Photographing Device” filed Mar. 10, 2004, in the Korean Intellectual Property Office, the entire contents of which are incorporated herein by reference.

### BACKGROUND OF THE INVENTION

1. Field of the Invention

The present invention relates, in general, to a mode selection switch of a photographing device. More particularly, the present invention relates to a mode selection switch of a photographing device for selecting an operational mode of the photographing device.

2. Description of the Related Art

Conventional digital still cameras (DSC) convert images that enter through a lens into a digital signal, and store the digital signal in a recording medium such as a memory card. Unfortunately, however, currently available recording medium used in the DSC has such small capacity that the DSC is mainly used for photographing still images. Although the DSC is capable of photographing moving images for a limited period of time, it cannot photograph them for an extended period of time. In addition, the DSC does not have any device for recording and reproducing sound when the moving image is played. Therefore, DSC's are generally not the best choice for photographing moving images and storing and reproducing the photographed moving images. To overcome these problems, a recording/reproducing device that is capable of recording and reproducing the image and sound of a subject stored in a recording medium (e.g., a magnetic tape), such as a camcorder (i.e., digital video camcorder (DVC)), is broadly used.

Since the DVC uses a magnetic tape as its recording medium, it is capable of photographing moving images for an extended period of time. Because the picture quality of the DVC is somewhat poorer that that of the DSC, many people use the DVC for photographing moving images.

Consumers, therefore, usually purchase a DVC and a DSC to record moving and still images, respectively. This, however, is expensive. In addition, carrying two products together and using each according to its own functions is inconvenient to most consumers.

As an attempt to solve the problems discussed above, a combination DVC/DSC has been developed. The user is therefore given the option to choose either the DVC or DSC for photographing images. Because the DVC and the DSC are separately operated, the user can change the operation mode of the photographing device from the DVC mode to the DSC mode or vice versa at any time.

When using such a combination DVC/DSC, the user cannot photograph moving and still images without changing the operation mode frequently. Therefore, a mode selection switch for changing the operation mode is usually located on the case of the combination DVC/DSC where the user can easily operate it. One frequently used mode selection switch is a multi-step switch. The operation mode selection switch is also used for reproducing recorded images in the combination DVC/DSC recording/reproducing device (photographing device) or selecting a power off mode for turning off a power supply to the photographing device.

If the photographing device is operated in more than three different operation modes, the user personally must verify the operation modes displayed on the mode selection switch. Many users find this very inconvenient. Especially when a user wants to photograph an important scene by using the DSC while photographing a moving image using the DVC, the user has to take his eyes off the viewfinder or LCD of the photographing device to move the mode selection switch. Even if the user takes her eyes off the viewfinder of LCD momentarily, the subject image focused on the lens of the photographing device may change. Moreover, as its name implies, the DVC/DSC combination unit has more functions than other photographing devices. Some of the functions are frequently used by the user but many functions are not.

Therefore, there is a need to arrange the more frequently used functions of the photographing device in a position where the user can easily find and operate them. This will aid the user to have more confidence in operating the photographing device with more complicated functions.

### SUMMARY OF THE INVENTION

Accordingly, it is an object of the present invention to provide a mode selection switch for use in a photographing device having at least three favorite operation modes of a user so that the user can select a desired operation mode.

In order to achieve the above-described objects of the present invention, there is provided a mode selection switch of a photographing device for selecting one of first, second, and third operation modes, wherein the switch comprises: a mode display unit for displaying the first operation mode with a highest usage frequency at one end, displaying the second operation mode with a second highest usage frequency at the other end, and displaying the third operation mode with a third highest usage frequency at the center of both ends, and a mode selection unit for indicating the first, second, and third operation modes arranged in order on the mode display unit, and to which a user inputs a mode selection command to select one of the first, second, and third operation modes.

The mode selection unit can according to an embodiment of the present invention indicate, through rotation, one of the first, second, and third operation modes in sequence. The mode selection unit can also indicate, through linear motion, one of the first, second, and third operation modes in sequence. If the user holds the photographing device with one hand, the mode selection switch is operable by the user's thumb and index finger of the hand holding the photographing device.

According to an exemplary embodiment of the present invention, the first operation mode is a first photograph mode for recording photographed images through a first photographing block in a recording medium mounted in the photographing device, and the second operation mode can be a second photograph mode for recording photographed images through a second photographing block in the recording medium mounted in the photographing device. The first photographing block can be a DVC photograph mode for photographing images that include moving images, and the second photographing block can be a DSC photograph mode for photographing images that include still images. The third operation mode according to an exemplary embodiment of the present invention can be in Play mode for playing or reproducing the images received in the recording medium on a display block mounted on the photographing device, or a Power OFF mode for turning off power to the photographing device.

According to an exemplary embodiment of the present invention, the first operation mode can be a photograph mode for recording in a recording medium images that are photographed by using the photographing block mounted in the photographing device, and the second operation mode can be a photograph mode for displaying the images that are recorded in the recording medium on a display block mounted in the photographing device. The third operation mode can be a power off mode for turning off power to the photographing device.

The menu display unit according to an exemplary embodiment of the present invention can display a menu screen consisting of the first operation mode, the second operation mode, and the third operation mode. The mode selection unit can allow a user to input a mode selection command by moving a cursor to one of the first, second, and third operation modes arranged in order on the menu screen.

### BRIEF DESCRIPTION OF THE DRAWINGS

The above aspects and features of the present invention will be more apparent by describing certain embodiments of the present invention with reference to the accompanying drawings, in which:

FIG. 1 is a schematic block diagram of a photographing device according to an embodiment of the present invention;

FIG. 2A and FIG. 2B respectively illustrate a mode selection switch of a photographing device according to a first embodiment of the present invention;

FIG. 3 illustrates a mode selection switch of a photographing device according to a second embodiment of the present invention;

FIG. 4A and FIG. 4B respectively illustrate a menu screen and a menu dial used for a mode selection switch of a photographing device according to a third embodiment of the present invention; and

FIG. 5 is a flowchart provided for the explanation of a mode selection method of a photographing device according to a fourth embodiment of the present invention.

### DETAILED DESCRIPTION OF THE EXEMPLARY EMBODIMENTS

Several embodiments of the present invention will now be described in detail with reference to the annexed drawings. In the drawings, the same or similar elements are denoted by the same reference numerals even though they are depicted in different drawings. In the following description, a detailed description of known functions and configurations incorporated herein have been omitted for conciseness and clarity.

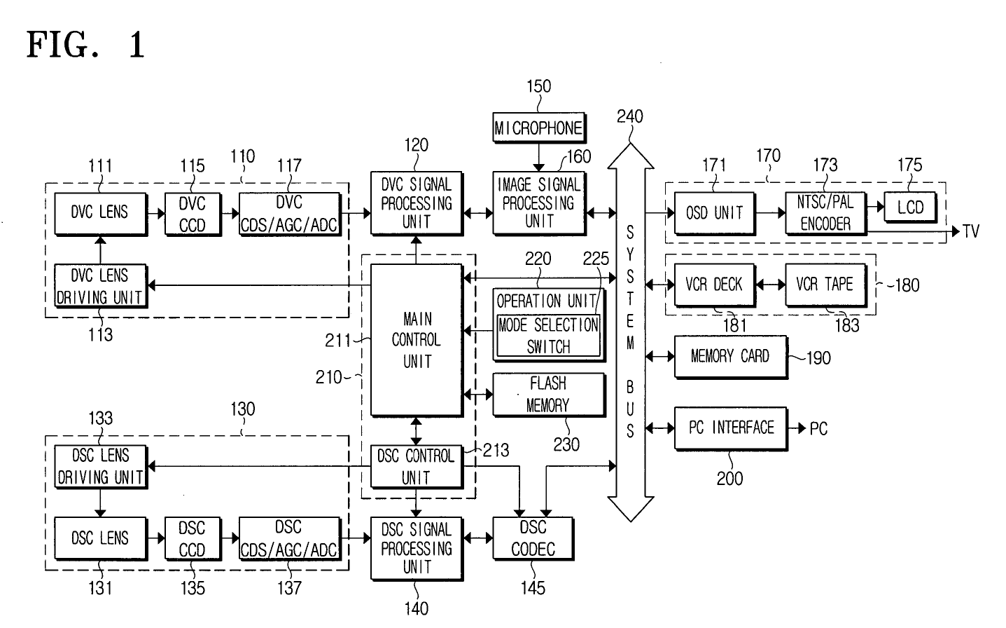

FIG. 1 is a block diagram illustrating a photographing device according to an embodiment of the present invention. As shown in FIG. 1, the photographing device includes a DVC photographing block 110, a DVC signal processing unit 120, a DSC photographing block 130, a DSC signal processing unit 140, DSC coder/decoder (CODEC) 145, a microphone 150, a memory card 190, PC interface 200, a control block 210, an operation unit 220, flash memory 230, and a system bus 240.

The DVC photographing block 110 photoelectrically converts a light signal that passes through the lens, and performs a designated signal process on the converted signal. The DVC photographing block 110 can photograph both moving images and still images. The picture quality of the still image photographed by the DVC photographing block 110, however, is of much poorer quality than that of the still image photographed by the DSC photographing block 130. Therefore, the DVC photographing block 110 is mainly used for photographing moving images.

The DVC photographing block 110 includes a DVC lens 111, a DVC lens driving unit 113, a DVC charge Coupled device (CCD) 115, and a DVC correlated double sampler/auto gain controller/analog-to-digital converter (CDS/AGC/ADC) 117. The DVC lens driving unit 113 is under the control of the control block 210, and drives the DVC lens 111. The DVC lens driving unit 113 can, under the control of the control block 210, zoom in and zoom out the DVC lens 111, automatically focuses the DVC lens 111, and adjusts the aperture size of a diaphragm (not shown) of the DVC lens 111.

The DVC CCD 115 converts an optical image that passes through the DVC lens 111 into an electrical signal, and outputs the converted signal. The optical image of a subject is formed on the optical surface of the DVC CCD 115, and the DVC CCD 115 converts the optical image formed on the photo-sensitive surface into an electric signal, and outputs it in the form of one-dimensional electric signal through scanning in horizontal and vertical directions.

The DVC CDS/AGC/ADC 117 removes noise from the signal output from the DVC CCD 115 by using the CDS, adjusts a gain by using the AGC to keep the signal's level constant, and converts the output signal to a digital signal by using the ADC. The DVC signal processing unit 120 performs a designated signal process on the digital signal received from the DVC photographing block 110, and applies it to an image signal processing unit 160. The DVC signal processing unit 120 separates the signal applied from the DVC photographing block 110 into a luminance (Y) signal and a chrominance (C) signal. The DVC signal processing unit 120 assists the DVC CDS/AGC/ADC 117 in gain control, assists the main control unit 211 in focusing, and provides an auto white balance (AWB) function, thereby improving the resolution.

The microphone 150 converts an externally input audio signal into an electric signal, and outputs it to the image signal processing unit 160. The image signal processing unit 160 applies the processed image signal from the DVC signal processing unit 120 to a display block 170.

When the image signal processing unit 160 receives a ‘photograph command’ that the user inputs to the operation unit 220, it compresses the output signal from the DVC signal processing unit 120 into a digital video signal. The image signal processing unit 160 also converts the output signal from the microphone 150 into a digital signal, and compresses the digitized audio signal into a pulse code modulated (PCM) signal. The image signal processing unit 160, under the control of the control block 210, applies the compressed signals for recording to a VCR block 180.

If the photographing device is operated in ‘VCR play’ mode, the image signal processing unit 160, under the control of the control block 210, receives the compressed image signals from the VCR block 180 to be played or reproduced. The image signal processing unit 160 then decompresses the compressed image signals and applies them to the display block 170.

The DSC photographing block 130 photoelectrically converts a light signal that passes through the lens, and performs a designated signal process on the converted signal. The DSC photographing block 130 can photograph both moving images and still images. The data storage capacity required for moving images photographed by the DSC photographing block 130 is much larger than that of moving images photographed by the DVC photographing block 110. This means that more storage is required to record the moving image data in the recording medium, so it is impossible to photograph moving images for an extended period of time. Therefore, the DSC photographing block 130 is mainly used for photographing still images.

The DSC photographing block 130 includes a DSC lens 131, a DVC lens driving unit 133, a DSC CCD 135, and a DSC CDS/AGC/ADC 137. The DSC lens driving unit 133, under the control of the control block 210, drives the DSC lens 131. The DSC lens driving unit 133 zooms in and out the DSC lens 131, automatically focuses, and adjusts the aperture size of a diaphragm (not shown) of the DSC lens 131. The DSC CCD 135 converts an optical image that passes through the DSC lens 131 to an electric signal, and outputs the converted signal.

The DSC CDS/AGC/ADC 137 removes noise from the signal output from the DSC CCD 135 by using the CDS, adjusts the gain by using the AGC to keep the signal's level constant, and converts the output signal to a digital signal by using the ADC. The DSC signal processing unit 140 performs a designated signal process on the digital signal received from the DSC photographing block 130. The DSC signal processing unit 140 separates the signal applied from the DSC photographing block 140 into a luminance (Y) signal and a chrominance (C) signal. The DSC signal processing unit 140 assists the DSC CDS/AGC/ADC 137 in gain control, assists the main control unit 211 in focusing, and provides an auto white balance (AWB) function, thereby improving the resolution.

The DSC CODEC 145 applies the image signal processed by the DSC signal processing unit 140 to the display block 170. When the DSC CODEC 145 receives a ‘photograph command’ that the user inputs to the operation unit 220, it compresses the output signal from the DSC signal processing unit 140 into a JPEG signal. The DSC CODEC 145, under the control of the control block 210, records the compressed signal in the memory card 190.

Alternatively, if the photographing device is operating in ‘memory card reproduce’ mode, the DSC CODEC 145, under the control of the control block 210, receives the compressed image signals from the memory card 190 to be played or reproduced. The DSC CODEC 145 then expands the compressed image signals and applies them to the display block 170.

The display block 170 displays signals output from the image signal processing unit 160 and the DSC CODEC 145. The display block 170 includes an on screen display (OSD) 171, an National Television System Committee/phase alternation line (NTSC/PAL) encoder (NTSC/PAL) 173, and a liquid crystal display (LCD) 175.

The OSD unit 171 stores OSD characters and graphics user interface (GUI) data, (e.g., a menu screen) required for constructing the GUI environment. The OSD unit 171, under the control of the control block 210, combines output images from the image signal processing unit 160 and the DSC CODEC 145 with the OSD characters or GUI data. The NTSC/PAL encoder 173 converts the image signals output from the OSD unit 171 to NTSC signals or PAL signals, and applies them to an external device (e.g., a TV). The LCD 175 displays the images applied from the NTSC/PAL encoder 241.

The VCR block 180 records image signals output from the image signal processing unit 160, or reads the image signals being recorded to apply them to the image signal processing unit 160. The VCR block 180 includes a VCR deck 181 and a VCR tape 183. VCR tape 183 is a magnetic recording medium capable of recording image signals, and is detachable from the VCR deck 181. The VCR deck 181 records image signals applied from the image signal processing unit 160 on the VCR tape 183, or reads the image signals recorded in the VCR tape 183 to apply them to the image signal processing unit 160.

The memory card 190 is another recording medium capable of recording image signals applied from the DSC CODEC 145, and is detachable from the photographing device. The PC interface 200 interfaces with an external device, such as a PC or a printer.

The control block 210 controls general operations of the photographing apparatus, according to user-input operation commands through the operation unit 220. The control block 210 controls the DVC photographing block 110 or the DSC photographing block 130 to photograph in response to the commands input by the user. The control block 210 includes a main control unit 211 and a DSC control unit 213.

In operation, the main control unit 211 receives an operation command that the user input to the operation block 220, and controls the operations of the DVC lens driving unit 113, the DVC signal processing unit 120, the image signal processing unit 160, the OSD unit 171, the VCR deck 181, and the PC interface 200. The main control unit 211 also controls the operation of the DSC control unit 312.

The DSC control unit 213, under the control of the main control unit 211, controls the operations of the DSC lens driving unit 133, the DSC signal processing unit 140, and the DSC CODEC 145. The flash memory 230 is used to backup important data after power is turned off. The flash memory 230 is also used to backup important data when a system program for use in the operation of the apparatus, such as the booting program needed at the main control unit 230, is turned off.

The operation unit 220 is a user interface for receiving operation commands from the user associated with the selection of a plurality of functions and operating control of the photographing device. The operation unit 220 includes a mode selection switch 225, through which the user selects an operation mode of the photographing device.

The mode selection switch 225 will now be described in greater detail below. The mode selection switch 225 is one of the most frequently used operation buttons in the operation unit 220, so it is preferably located at a position where the user can easily operate it. For example, if the user is holding the photographing device with his one hand, the mode selection switch 225 should be located at a position the user can easily operate it with the user's thumb or index finger of the hand holding the photographing device.

The photographing device operates in at least four different modes: i) a ‘DVC photograph’ mode for recording images photographed by the DVC photographing block 110; ii) a ‘DSC photograph’ mode for recording images photographed by the DSC photographing block 130; iii) a ‘Play’ mode for playing or reproducing images recorded in the VCR block 180; and iv) an ‘OFF’ mode for turning off power to the photographing device. Therefore, the mode selection switch 225 allows the user to choose one of those four operation modes.

FIG. 2A illustrates a mode selection switch 225 of the photographing device according to the first embodiment of the present invention. Referring to FIG. 2A, the mode selection switch 225 is a rotatory multi-step switch. The mode selection switch 225 includes a mode display unit 225a and a mode selection unit 225b. The mode display unit 225a is similar to an operation mode guide that the user refers to for operation of the mode selection switch 225. Therefore, the mode display unit 225a displays every operation mode the user can choose.

As described above, the photographing device is operated in one of four different modes: DVC photograph mode, DSC photograph mode, Play mode, and OFF mode. Accordingly, the mode display unit 225a displays the four operation modes. The mode selection unit 225b rotates to an ‘A’ direction or ‘B’ direction with respect to the ‘X’ axis, by the operation of the user. The user rotates the mode selection unit 225b to select one of those four operation modes arranged in order (In FIG. 2A, the mode selection unit 225b is shown indicating the ‘OFF’ mode for example).

The mode selection unit 225b outputs to the main control unit 211 different mode selection command signals according to its rotational angle (i.e., the selected operation mode). The main control unit 211 ensures that the photographing device is operated in the operation mode that corresponds to the mode selection command signal from the mode selection unit 225b. When the user rotates the mode selection unit 225b and stops at one of the operation modes arranged at the mode display unit 225a, the photographing device starts operating in the operation mode the user chose.

The arrangement of those four operation modes at the mode display unit 225a is determined according to the usage frequency or the user's preference. The most selected operation mode is placed at a more convenient position for the user to select. Normally, the ‘DVC photograph’ mode and the ‘DSC photograph’ mode are the most frequently used operation modes out of the four and thus, the selected frequencies of these two modes are higher than the other two operation modes. Therefore, the ‘DVC photograph’ mode and the ‘DSC photograph’ mode should be arranged at more convenient positions for the user to select.

As shown in FIG. 2A, the mode selection switch 225 is a rotating multi-step switch, and its top end and bottom end of the mode display unit 225a are located where the user can easily select the switch. To make the mode selection unit 225b indicate the top end of the mode display unit 225a, the user only needs to push the mode selection unit 225b to the ‘B’ direction. When the user pushes the mode selection unit 225b to the ‘B’ direction, the mode selection unit 225b rotates until it hits the top end of the mode display unit 225a, stops, and rotates no more.

To make the mode selection unit 225b indicate the bottom end of the mode display unit 225a, the user only needs to push the mode selection unit 225b to the ‘A’ direction. When the user pushes the mode selection unit to the ‘A’ direction, the mode selection unit 225b keeps rotating until it hits the bottom end of the mode display unit 225a, stops, and rotates no more.

As described above, once the mode selection unit 225b hits the top end or the bottom end of the mode display unit 225a, it stops and rotates no more. Thus the most frequently used operation modes are located at the top end and the bottom end of the mode display unit 225a for the user's convenience.

To select an operation mode that is located at the center of the top end and the bottom end of the mode display unit 225a (such as, the ‘Play’ mode and the ‘OFF’ mode in FIG. 2), the user has to see where the operation mode he wants to choose is located. Moreover, to select the corresponding operation mode by rotating the mode selection unit 225b, the user needs be more careful. the user cannot simply push the mode selection unit 225b, but should preferably push it more gently. Therefore, selecting the operation modes at the central portion of the mode display unit 225a is much harder and inconvenient than selecting the operation modes located at the top end or the bottom end of the mode display unit 225a.

These are the reasons why the ‘DVC photograph’ mode and the ‘DSC photograph’ mode with higher selected frequencies are located at the top end and the bottom end of the mode display section 225a, respectively, as shown in FIG. 2A. If the positions of the ‘DVC photograph’ mode and the ‘DSC photograph’ mode were exchanged with each other, as shown in FIG. 2B, the user would generally not notice the difference. Therefore, as shown in FIG. 2B, the ‘DVC photograph’ mode can be located at the bottom end of the mode display unit 225a and the ‘DSC photograph’ mode at the top end of the mode display unit 225a.

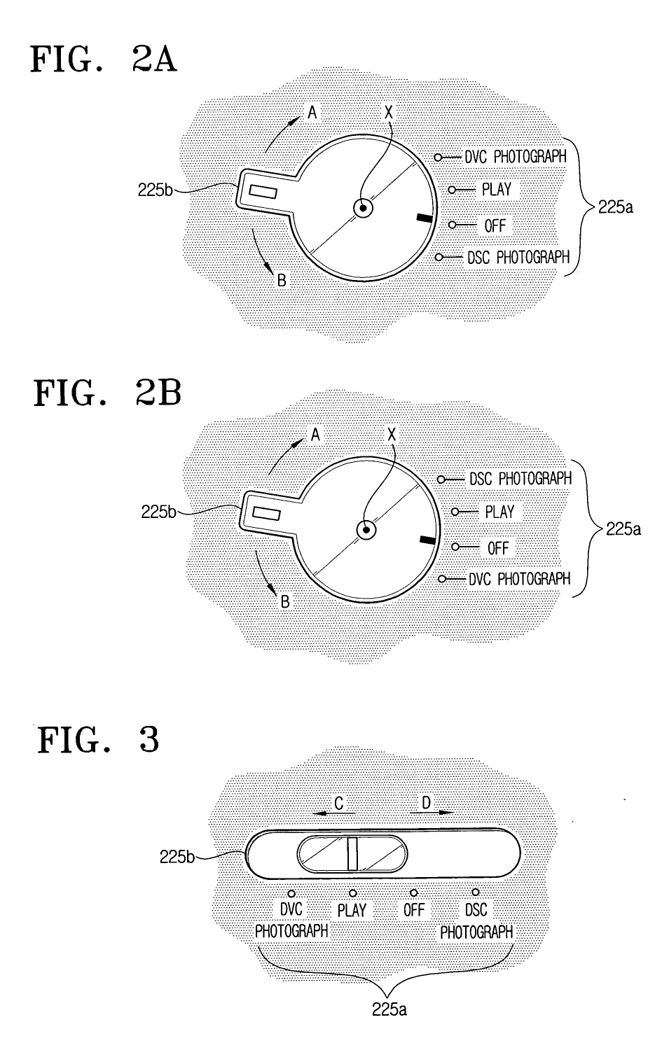

FIG. 3 illustrates a mode selection switch 225 of the photographing device, according to the second embodiment of the present invention. As shown in FIG. 3, the mode selection switch is a linear multi-step switch. According to the operation of the user, the mode selection unit 225b is linearly moved in either the ‘C’ direction or the ‘D’ direction, indicating one of the four operation modes arranged on the mode display unit 225a (for example, the mode selection unit 225b in FIG. 3 indicates the ‘Play’ mode).

In the case of the linear multi-step mode selection switch 225, the far left end and the far right end of the mode display unit 225a are the most convenient positions for the user to select. To make the mode selection unit 225b indicate the far left end of the mode display unit 225a, the user only needs to push the mode selection unit 225b as far as it can go in the ‘C’ direction. Likewise, to make mode selection unit 225b indicate the far right end of the mode display unit 225a, the user only needs to push the mode selection unit 225b as far as it can go in the ‘D’ direction. The mode selection unit 225b keeps moving until it hits the far left end or far right end of the mode display unit 225a. The mode selection unit 225b then stops and slides no more.

For the above reasons, the ‘DVC photograph’ mode and the ‘DSC photograph’ mode with higher selected frequencies are located at the far left end and the far right end of the mode display section 225a, respectively, as shown in FIG. 3. Also, the positions of the ‘DVC photograph’ mode and the ‘DSC photograph’ mode can be exchanged with each other.

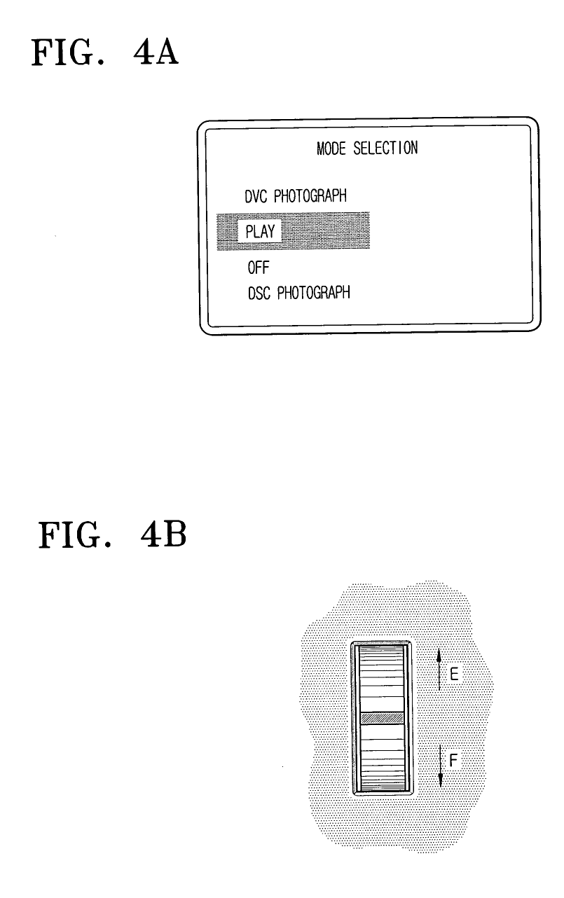

In the third embodiment of the present invention which will be described hereinafter, the user-selectable operation modes are displayed on the menu screen. FIG. 4A and FIG. 4B respectively illustrate a menu screen and a menu dial used for the mode selection switch of a photographing device according to the third embodiment of the present invention.

FIG. 4A illustrates a mode selection menu screen provided from the OSD unit 171 under the control of the main control unit 211. The operation modes displayed on the menu screen are ‘DVC photograph’ menu, ‘Play’ mode, ‘OFF’ menu, and ‘DSC photograph’ mode, and a cursor indicates which one is selected. Therefore, in operation, the user moves the cursor to select the desired operation mode. After the desired operation mode is selected, the photographing device starts its operation in the operation mode corresponding to the user-selected menu.

FIG. 4B illustrates a menu dial that is used for moving the cursor to a specific menu the user wants. When the user pushes up the menu dial in the ‘E’ direction, the cursor on the menu screen moves up (or in the ‘E’ direction) also. Alternatively, when the user pushes the menu dial in the ‘F’ direction, the cursor on the menu screen moves down accordingly. After the user moves the cursor to the desired operation mode, the user presses the menu dial and the photographing device operates in the operation mode that the cursor indicates.

As with the mode display unit 225a, the most frequently or preferred menus will preferably be at the top end or the bottom end of the menu screen, because these are the positions the user can easily locate with the cursor. When the user rolls the menu dial to the ‘E’ or ‘F’ direction, the cursor moves to the top end or the bottom end of the menu screen and stops.

For the reasons discussed above, the ‘DVC photograph’ mode and the ‘DSC photograph’ mode with the higher selected frequencies are located at the top end and the bottom end on the menu screen, respectively, as shown in FIG. 4A. Of course, the positions of the ‘DVC photograph’ mode and the ‘DSC photograph’ mode can be exchanged with each other. Also, if the menu items on the menu screen are arranged in the horizontal direction, as opposed to the vertical direction shown in FIG. 4A, the ‘DVC photograph’ mode and the ‘DSC photograph’ mode with higher selected frequencies are preferably located at the far left end and the far right end on the menu screen, respectively,

For purposes of this discussion, it has been assumed that the ‘DVC photograph’ mode and the ‘DSC photograph’ mode have the higher selected frequencies. This, of course, may not necessarily be the case. Therefore, if the ‘DVC photograph’ mode and the ‘Play’ mode have higher selected frequencies, these modes can be arranged at the top end/bottom end or at the far left end/right end.

In addition, the four operation modes of the photographing device, i.e., ‘DVC photograph’ mode, ‘DSC photograph’ mode, ‘Play’ mode, and ‘OFF’ mode, described in the embodiments of the present invention are illustrative only. Therefore, if desired, other operation modes can be added. The total number of the operation modes does not need to be limited to 4. In most cases, three operation modes are sufficient to operate the photographing device.

In the embodiments of the present invention described herein, the control block 210 included the main control unit 211 and the DSC control unit 213, and the functions of each control unit was different from each other. This too is illustrative only and the embodiments of the present invention need not be limited to this arrangement. Therefore, one control block 210 can be designed to control the general operations of the photographing device.

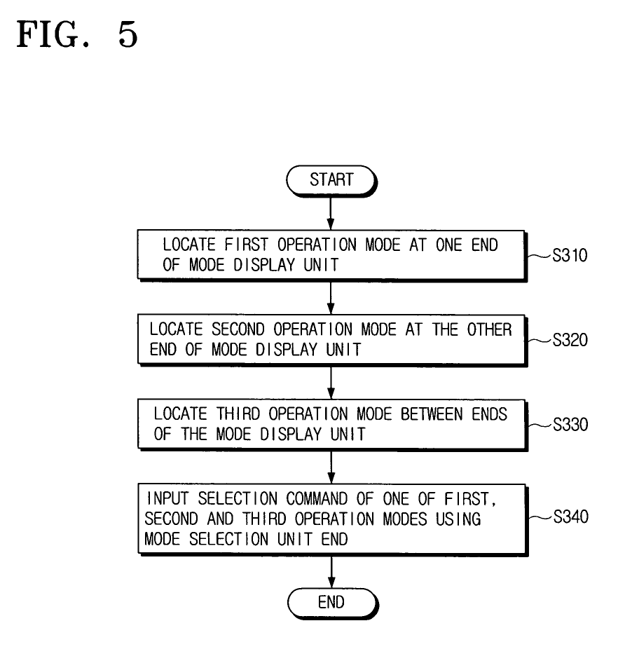

A mode selection method of a photographing device will now be described in greater detail below with reference to FIG. 5. FIG. 5 is a flowchart provided for the explanation of a mode selection method of a photographing device according to a fourth embodiment of the present invention.

In the description of the fourth embodiment as follows, an operation mode with a highest usage frequency will be referred to as a first operation mode, an operation mode with a second highest usage frequency will be referred to as a second operation mode, and an operation mode with a third highest usage frequency will be referred to as a third operation mode.

Referring to FIG. 5, the first operation mode is located at one end of the mode display unit 225a (step S310), the second operation mode is located at the other end of the mode display unit 225a (step S320), and the third operation mode is located between the ends of the mode display unit 225a (step S330), respectively.

Next, a mode selection command is inputted to select one of first, second, and third operation modes, using the mode selection unit 225b (step S340).

In operation S340, the mode selection unit 225b may be used to indicate the first, second, and third operation modes in sequence by a rotary, or a linear movement.

The mode selection unit 225b may be located such that it can be operated by the user's selection with the thumb and index finger of the hand holding the photographing device.

Additionally, the first operation mode, the second operation mode, and the third operation mode may be displayed as a menu screen in the operations from S310 to S330. In this case, the user may input a mode selection command by moving a cursor to one of the first, second, and third operation modes arranged in order on the menu screen.

In conclusion, according to the mode selection switch of the photographing device for selecting one of at least three operation modes, the user's preference or the selected frequencies of the modes are considered to arrange the operation mode. Therefore, the user can more easily select the modes more frequently used, without having to look at the mode selection switch. Therefore, the user's convenience is substantially increased.

The foregoing embodiments and advantages are merely exemplary and are not to be construed as limiting the present invention. The present teaching can be readily applied to other types of apparatuses. Also, the description of the embodiments of the present invention is intended to be illustrative, and not to limit the scope of the claims, and many alternatives, modifications, and variations will be apparent to those skilled in the art.

1. A mode selection switch of a photographing device for selecting one of first, second, and third operation modes, the mode selection switch comprising:
a mode display unit for displaying the first operation mode with a highest usage frequency at one end, displaying the second operation mode with a second highest usage frequency at the other end, and displaying the third operation mode with a third highest usage frequency between both ends; and
a mode selection unit for indicating the first, second, and third operation modes arranged in order on the mode display unit, and to which a user inputs a mode selection command to select one of the first, second, and third operation modes.

2. The mode selection switch according to claim 1, wherein the mode selection unit indicates, through a rotation of the mode selection switch, one of the first, second, and third operation modes in sequence.

3. The mode selection switch according to claim 1, wherein the mode selection unit indicates, through a linear motion of the mode selection switch, one of the first, second, and third operation modes in sequence.

4. The mode selection switch according to claim 1, wherein if the user holds the photographing device with one hand, the mode selection switch is operable by the user's thumb and index finger of the hand holding the photographing device.

5. The mode selection switch according to claim 1, wherein the first operation mode comprises a first photograph mode for recording photographed images through a first photographing block in a recording medium mounted in the photographing device, and the second operation mode comprises a second photograph mode for recording photographed images through a second photographing block in the recording medium mounted in the photographing device.

6. The mode selection switch according to claim 5, wherein the first photographing block comprises a digital video camcorder (DVC) photographing block for photographing images including moving images; and the second photographing block comprises a digital still camera (DSC) photographing block for photographing images including still images.

7. The mode selection switch according to claim 1, wherein the third operation mode comprises one of a Play mode for playing or reproducing the images in the recording medium on a display block mounted in the photographing device, or a power off mode for turning off power to the photographing device.

8. The mode selection switch according to claim 1, wherein the first operation mode comprises a photograph mode for recording in a recording medium images that are photographed by using the photographing block mounted in the photographing device, and the second operation mode comprises a play mode for displaying the images that are recorded in the recording medium on a display block mounted in the photographing device.

9. The mode selection switch according to claim 8, wherein the third operation mode comprises a power off mode for turning off power of the photographing device.

10. The mode selection switch according to claim 1, wherein the mode display unit displays a menu screen comprising the first operation mode, the second operation mode, and the third operation mode; and the mode selection unit allows a user to input a mode selection command by moving a cursor to one of the first, second, and third operation modes arranged in order on the menu screen.

11. The mode selection switch according to claim 10, wherein the mode selection unit indicates, through a linear motion of the mode selection switch, one of the first, second, and third operation modes in sequence.

12. A method of operating a photographing device, comprising:
displaying a first operation mode with a highest usage frequency at one end of a display unit;
displaying a second operation mode with a second highest usage frequency at the other end of the display unit;
displaying a third operation mode with a third highest usage frequency between the ends of the display unit; and
selecting one of first, second, and third operation modes, using a mode selection unit to input a mode selection command.

13. The method according to claim 12, wherein the step of selecting one of first, second, and third operation modes comprises:
rotating the mode selection unit to indicate the first, second, and third operation modes in sequence.

14. The method according to claim 12, wherein the step of selecting one of first, second, and third operation modes comprises:
moving linearly the mode selection unit to indicate the first, second, and third operation modes in sequence.

15. The method according to claim 12, further comprising:
operating the mode selection unit by the user's thumb and index finger of the hand holding the photographing device.

16. The method according to claim 12, wherein the first operation mode comprises a first photograph mode for recording photographed images through a first photographing block in a recording medium mounted in the photographing device, and the second operation mode comprises a second photograph mode for recording photographed images through a second photographing block in the recording medium mounted in the photographing device.

17. The method according to claim 12, wherein the third operation mode comprises one of a Play mode for playing or reproducing the images in the recording medium on a display block mounted in the photographing device, or a power off mode for turning off power to the photographing device.

18. The method according to claim 12, wherein the first operation mode comprises a photograph mode for recording in a recording medium images that are photographed by using the photographing block mounted in the photographing device, the second operation mode comprises a play mode for displaying the images that are recorded in the recording medium on a display block mounted in the photographing device, and the third operation mode comprises a power off mode for turning off power of the photographing device.

19. The method according to claim 12, further comprising:
displaying a menu screen on the display unit comprising the first operation mode, the second operation mode, and the third operation mode; and
allowing the user to input a mode selection command by moving a cursor to one of the first, second, and third operation modes arranged in order on the menu screen.

20. The method according to claim 19, wherein the step of allowing the user to input a mode selection command comprises:
moving in a linear motion a mode selection switch to select one of the first, second, and third operation modes in sequence.
